(19) United States
(12) Patent Application Publication
(10) Pub. No.: US 2026/0147607 A1
(43) Pub. Date: May 28, 2026

(54) MULTI-MODEL FINE TUNING AND INFERENCE

(71) Applicant: INTERNATIONAL BUSINESS MACHINES CORPORATION, Armonk, NY (US)

(72) Inventors: Saransh Gupta, Sunnyvale, CA (US); Umesh Deshpande, San Jose, CA (US); Travis Janssen, San Jose, CA (US); Swaminathan Sundararaman, San Jose, CA (US)

(21) Appl. No.: 18/957,725

(22) Filed: Nov. 23, 2024

(51) Int. Cl. G06F 9/48

(52) U.S. Cl. CPC G06F 9/4843

(57) ABSTRACT

Multi-model fine turning and inference includes batching, by a base executor, a plurality of requests received from a plurality of client executors into a request batch. Each request specifies input data and requests offload processing of the input data by a selected layer of a plurality of layers of a base model of the base executor. The base executor processes the requests of the request batch through the selected layer to generate, for each request of the request batch, an output corresponding to the request. Each output is transmitted from the base executor to the client executor that submitted the request corresponding to the output. The outputs generated in response to the batched requests enable the one or more client executors to perform specific tasks.

### BACKGROUND

This disclosure relates to artificial intelligence (AI), and, more particularly, to fine tuning models and generating inferences with fine-tuned models adapted from a pre-trained foundation model.

Foundation models are large deep learning neural networks trained with massive amounts of data. A fundamental feature of foundation models is adaptability. A foundation model can be adapted for performing a wide variety of disparate tasks such as understanding diverse languages, generating text and images, and conversing in a natural language. Increasingly, a foundation model serves as a base model for developing a new, task-specific machine learning model using a specially trained adapter. Adapters provide an alternative to fine-tuning a foundation model in its entirety for each new task while maintaining model performance and significantly reducing the resources needed for adapting the foundation model to a specific task. An adapter is typically a small neural network that contains far fewer parameters than the foundation model, which is a large, pre-trained model such as a large language model (LLM) or generative AI system. Instead of adjusting all the pre-trained model's parameters—which may number in the millions or even billions—the far fewer parameters of the adapter are fine-tuned while those of the pre-trained model remain frozen. Adapting a foundation model for a specific task with an adapter is typically more efficient both in time and resources than building an AI model from scratch.

### SUMMARY

In one or more embodiments, a method of multi-model fine tuning and inference includes batching, by a base executor, a plurality of requests received from a plurality of client executors into a request batch. Each request specifies input data and requests offload processing of the input data by a selected layer or a plurality of layers of a base model by the base executor. The base executor processes the requests of the request batch through the selected layer to generate, for each request of the request batch, an output corresponding to the request. Each output is transmitted from the base executor to the client executor that submitted the request corresponding to the output. The outputs generated in response to the batched requests enable the one or more client executors to perform specific tasks.

In one or more embodiments, a system includes one or more processors configured to initiate executable operations as described within this disclosure.

In one or more embodiments, a computer program product includes one or more computer-readable storage media and program instructions collectively stored on the one or more computer-readable storage media. The program instructions are executable by a processor to cause the processor to initiate operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example architecture of a multi-model inference and fine tuning (MMIFT) framework.

FIG. 2 illustrates an example method of operation performed by the MMIFT framework of FIG. 1.

FIG. 3 illustrates certain operative aspects of the MMIFT framework of FIG. 1.

FIG. 4 illustrates certain other operative aspects of the MMIFT framework of FIG. 1.

FIG. 5 illustrates still other operative aspects of the MMIFT framework of FIG. 1.

FIG. 6 illustrates another example method of operation performed by the MMIFT framework of FIG. 1.

FIG. 7 illustrates still another example method of operation performed by the MMIFT framework of FIG. 1.

FIG. 8 illustrates yet another example method of operation performed by the MMIFT framework of FIG. 1.

FIGS. 9A-9D illustrate different arrangements of the MMIFT framework of FIG. 1.

FIG. 10 illustrates an example of a computing environment that is capable of implementing the MMIFT framework of FIG. 1.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to employ the features described in virtually any appropriately detailed structure. Further, the terms and phrases used within this disclosure are not intended to be limiting, but rather to provide an understandable description of the features described.

This disclosure relates to AI, and, more particularly, to fine tuning models and generating inferences with fine-tuned models adapted from a pre-trained foundation model. Parameter-Efficient Fine-Tuning (PEFT) and other fine-tuning techniques are available for fine tuning a large, pre-trained model. Generally, however, these techniques do not fully support simultaneously fine-tuning multiple adapters and generating inferences. With respect to fine tuning, for example, although typically it is the parameters (weights and biases) of an adapter that are trained while the pre-trained model's parameters remain largely untouched, input data passes through the layers of both the adapter and the pre-trained model. Thus, each instance of fine tuning typically necessitates deployment of the underlying base model with the adapter, resulting in excessive memory consumption and poor GPU utilization. Although conventional platforms may serve multiple adapters, these conventional platforms typically do not enable independent execution, efficient resource management, mixing of different methods (e.g., PEFT), or isolation of multiple adapters. For generating inferences, popular frameworks tend not to enable simultaneous generation of inferences with multiple adapters, limit resource consumption, provide adequate performance, or preserve the privacy of adapter parameters.

In accordance with the inventive arrangements described herein, methods, systems, and computer program products are provided that are capable of simultaneously performing both fine tuning of multiple adapters and generating inferences with multiple adapters. The inventive arrangements share parameters of a base model across multiple clients that implement different adapters for generating inferences or fine tuning a model. The base model constitutes layers and corresponding parameters of a large, pre-trained model (foundation model), such as an LLM or other type of generative AI model. Among the technological improvements of the inventive arrangements over conventional technology is the significant reduction of memory requirements for performing fine tuning and inference generation by the sharing of the base model among multiple clients.

As used herein, the expression “share a base model” means to enable each client to utilize or leverage the same underlying pre-trained model (base model) and corresponding parameters, allowing each client to separately perform disparate tasks without individually instantiating the base model to fine tune a foundation model with an adapter or generate an inference with a foundation model trained for a specific task with an adapter. Through this sharing, the adapter is capable of leveraging the same, underlying or foundational pre-trained model as other, different adapters for fine tuning or generating inferences. As used herein, a “fine-tuned model” means a model adapted from a large, pre-trained model and generated by fine tuning parameters (e.g., weights, biases) of the layers of the adapter. Accordingly, “fine tuning” refers to adapting the large, pre-trained model for a specific task by training the tunable parameters of the adapter, while keeping the base layers of the large, pre-trained model or base model unchanged.

With conventional technologies, to fine tune the parameters of an adapter for training the pre-trained model for a specific task, layers of the adapter are added to, or “stitched-in,” to the base layers of the pre-trained model. Hence the need with conventional technologies for an adapter to have its own instance of the base layers. With the inventive arrangements disclosed herein, however, an adapter is implemented in a client executor that needs only instances of the adapter layers. The client executor must process input data through adapter layers in conjunction with also processing the data through base layers. But rather than having its own instances of the base layers, the client executor instead selects specific base layers and offloads to the base executor input data. The base executor responds to the request by processing the received input data through the client executor-selected base layers. The base executor shares the base layers with the multiple client executors and performs base layer computations for the client executors in response to specific processing requests that convey input data and specify the specific base layer(s) through which the input data is to be processed by the base executor.

The inventive arrangements disclosed herein implement a split execution technique, which transparently splits model execution into two distinct parts. The first part utilizes base model layers provided by a base executor, and the second part utilizes base executor-specific components (e.g., adapter layer parameters). As used herein, “model execution” means performing machine learning operations to train a model or generate an inference with a trained model. Similarly, “processing” is used herein to mean passing input data through the layers of a deep neural network to generate an output by transforming the input data. The layers of the deep neural network, as with machine learning generally, may include tunable parameters (e.g., weights, biases) and non-linear activation functions for performing calculations on the input data as part of the process of generating an output.

The split execution is a technological improvement over conventional techniques in that split execution enables the base executor to serve multiple inference and/or fine-tuning clients (client executors) simultaneously. Another technological improvement with split execution is allowing the base executor and client executors to be deployed to, and execute on, different hardware components (e.g., GPUs) of the same or different nodes or devices, even in separate, secure environments. Accordingly, the base model and distinct models (e.g., foundation model fine-tuned by an adapter) implemented by the respective client executors may scale independently, which is yet another technological improvement over conventional technology. In still another technological improvement of the split execution over the conventional technology, the different client executors may execute different adapters while sharing the base model instance provided by the base executor.

In certain embodiments, a base executor is instantiated for sharing with multiple client executors the base layers of a base model, which comprises a plurality of base layers corresponding to a pre-trained model. The pre-trained model may be a large or foundation model such as an LLM or other generative AI model. The base executor simultaneously shares the base layers of the base model with each of the client executors and performs processing in response to requests of the client executors. Each request includes input data and requests that processing of the input data be offloaded to the base executor for processing through a specific base layer selected by the client executor. The base executor batches a plurality of requests received from a plurality of client executors into a request batch. The base executor processes the requests of the request batch through the client executor-selected layer to generate, for each request of the request batch, an output corresponding to the request. Passing the input data received with each request through the selected layer transforms the input data into an output. The base executor transmits each output to the client executor that submitted the request corresponding to the output. Output generated in response to the batched requests enables the client executors to perform specific tasks. The specific tasks may include both fine tuning and inference generation. Fine tuning adapts the pre-trained, large model to a specific task. Inference generation is performed by passing an input through the pre-trained model that has been fine-tuned for performing a specific inference or prediction.

A technical advantage of the base executor's hosting base layers of the base model among multiple client executors is that the client executors share the base model without each client executor needing its own dedicated instance of the base model. As a result, there is a significant reduction of memory requirements in handling multiple model-related tasks. A technical advantage of splitting execution between the base executor and client executors is that the client executors need not implement the same adapter for fine tuning or generating an inference.

Still another technical advantage is that both fine tuning and inference generation may be performed by sharing the base layers of the base model among the different client executors and splitting execution with the base executor. Accordingly, in some instances, both fine-tuning and inference-generation tasks may be simultaneously executed by the different client executors sharing the base model and operating in conjunction with the base executor. That is, a single instance of the base model may be executed to support simultaneous performance of inference and fine-tuning by the various client executors.

Another technical advantage of the inventive arrangements is reduced latency by avoiding lockstep when both fine tuning and inference are performed. With lockstep, inferences, which do not require generation of gradients, would be slowed by fine tuning, which does require the generation of gradients. At each base layer, requests are batched. The requests from different client executors may include requests related both to fine tuning and to inference generation. Processing both types of requests in a batch enhances throughput but may affect latency given that fine tuning requires additional processing (feed forward processing and backpropagation) that inference generation does not require. Breaking the lockstep allows a faster request (e.g., inference related) to proceed to the next layer for processing without having to wait for the slower request (e.g., related to fine tuning). At the next layer, the faster request is batched with another set of requests. Accordingly, breaking the lockstep enables the base executor to batch requests at each layer commensurate with the speed with which each request at each layer may be processed, thereby enhancing the overall speed of processing multiple requests.

In certain embodiments, requests may be selected by the base executor for batching by identifying forward pass requests among multiple requests received. At least one of the forward pass requests may relate to inference generation and at least one of the forward pass requests may relate to fine tuning. The base executor may batch the forward pass requests identified and generate outputs in response to the requests by forward passing data received with each of the forward pass requests through one or more selected base layers. A technical advantage of processing forward pass requests involving both fine tuning and inference generation is that both may be included in a single batch rather than processing requests in separate batches, which enhances throughput.

In other embodiments, requests may be selected by the base executor for batching by identifying backward pass requests among multiple requests received. The base executor may batch the requests in a single batch. If the base layer(s) through which input data is processed via a backward pass is a 1D convolution and/or linear layer, then base executor may discard rather than store inputs and/or outputs of each 1D convolution and/or linear layer. Output in response to each request may be generated by the base executor's performing matrix multiplication between gradients and parameters during a backward pass of input data. A technical advantage is memory saving by obviating the need to store inputs and/or outputs.

In some embodiments, the base executor may detect speeds with which the client executors pass input data through layers (adapter layers) of models implemented, respectively, by each of the client executors. The base executor detects the speeds when the client executors pass the input data through an initial set of layers in accordance with a lockstep requirement that sets a time limit for batching requests to offload processing to the batch executor. The base executor may successively relax the lockstep requirement until each client executor has passed input data through every layer of the models implemented, respectively, by each client executor. A technical advantage of the lockstep requirement is that it may be set to increase the number of requests batched, thereby enhancing throughput. Gradually relaxing the requirement such that an ever-smaller fraction of requests to offload processes are batched at each successive layer reduces latency by allowing faster processes to proceed without waiting for slower ones. Combining establishment of a lockstep requirement with subsequent sequential relaxation of the lockstep requirement provides a technical advantage by balancing the competing objectives of enhanced throughput and reduced latency.

In still other embodiments, client executors may add noise to activations (generated by activation functions of adapter layers) passed as inputs to the base executor when offloading processing of inputs to the base executor. Separately conveying the noise to the base executor enables the base executor to generate a noise effect parameter that the base executor subtracts from outputs generated with noisy input. The technical advantage of injecting noise into the inputs is to provide privacy protection to users of the client executors. Subtracting the noise effect from outputs generated by the base executor and conveyed to the client executors provides the technical advantage of ensuring the outputs conveyed are not corrupted and do not adversely affect the client executors' use of the outputs.

In yet another embodiment, if one client executor implements a previously fine-tuned adapter, then the previously fine-tuned adapter may be pushed onto the base model, where it is accessible at a selected endpoint of the base executor. The previously fine-tuned adapter may be further fine tuned into a new adapter by the same and/or other client executors. A technical advantage is that fine tuning may be cumulative, leading to successively refined adapters, which may be made available to multiple client executors.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

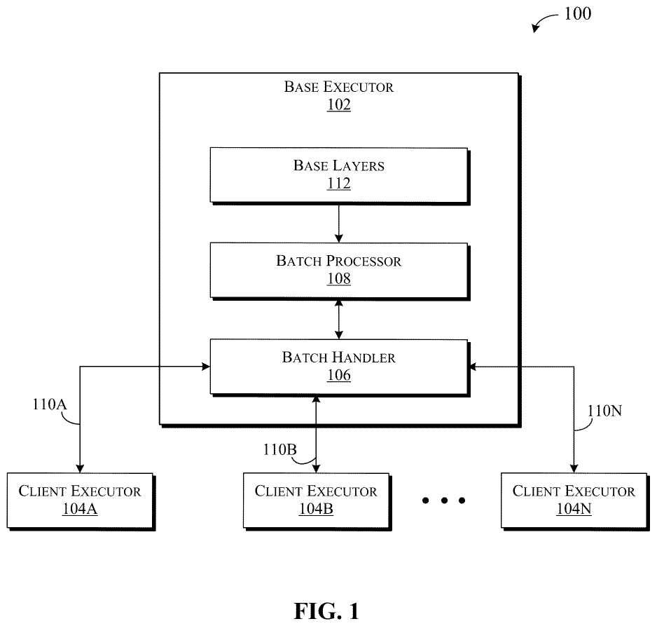

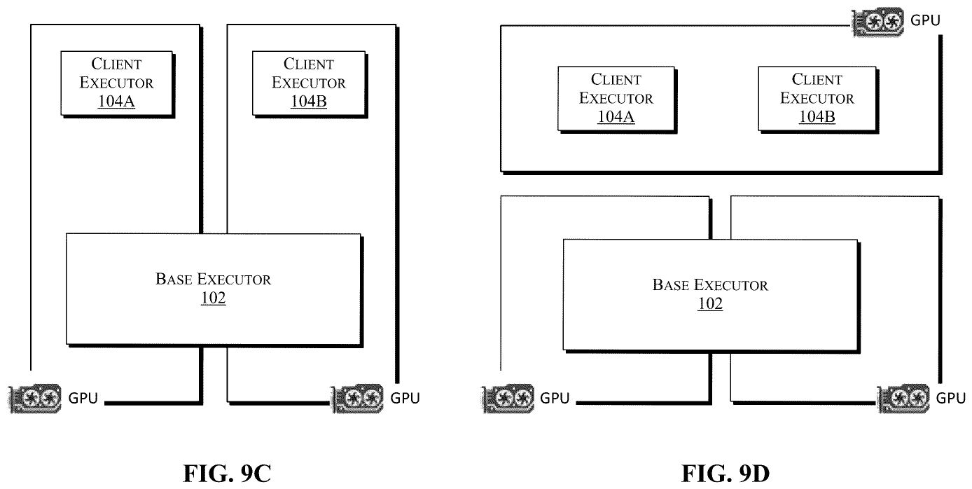

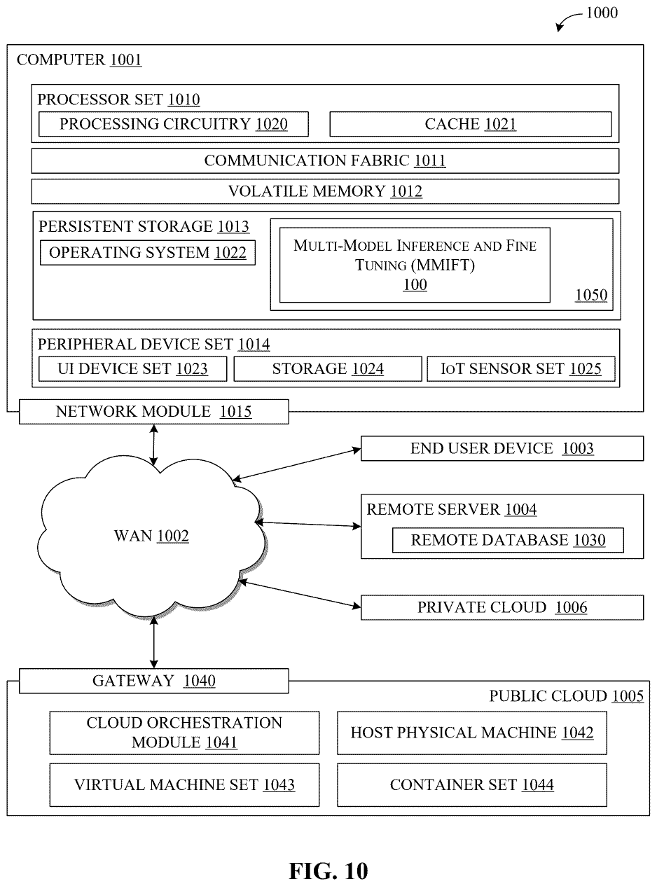

FIG. 1 illustrates an example architecture for a multi-model inference and fine tuning (MMIFT) framework 100, according to an embodiment of the present disclosure. In the example architecture of FIG. 1, MMIFT framework 100 illustratively includes base executor 102 and a plurality of client executors 104A and 104B through 104N. Illustratively, base executor 102 includes batch handler 106 and batch processor 108. Base executor 102 and client executors 104A-104N may be implemented in software that is executable on the hardware of one or more computers such as computer 1001 (FIG. 10). In various embodiments, described more fully below, base executor 102 and client executors 104A-104N may execute on the same hardware (e.g., the same graphics processing unit (GPU)) of the same node or device, or in other embodiments, on different hardware (e.g., different GPUs) of the same or different nodes or devices (FIGS. 9A-9D).

Base executor 102 communicatively couples with client executors 104A-104N via communication hooks 110A and 110B through 110N, respectively. Communication hooks 110A-110N provide a mechanism for customizing how data is communicated between base executor 102 and client executors 104A-104N and provide interfaces that may intercept and potentially modify the behavior of function calls, messages, or events passed between base executor 102 and client executors 104A-104N. In some embodiments, communication hooks 110A-110N may be part of an API. In various embodiments, for example, communication hooks 110A-110N control the passing of gradients and/or activations between base executor 102 and client executors 104A-104N during fine tuning of, or generating an inference with, a base model. The base model may be a pre-trained, large model, such as an LLM or another generative AI model.

Base layers 112 of the base model are hosted independently by base executor 102. Client executors 104A-104N invoke a forward/backward pass for a layer. Communication hooks 110A-110N provide additional logic to both forward and backward client functions that convey to base executor 102 a request specifying the input data and specific base layer for processing the input data. Accordingly, communication hooks 110A-110N may be part of the client-side forward/backward API. Base executor 102, in response to a request conveyed via a “request” communication hook, directs the request from the client executor to the appropriate base layer for processing. Requests from multiple clients targeting the same layer are batched for processing through the same base layer. Batch processing processes these requests together. Output generated by offloading the processing to base executor 102 in response to each request is distributed to the respective clients. A “receive” communication hook at each client executor collects the output corresponding to the specific request and specific client executor.

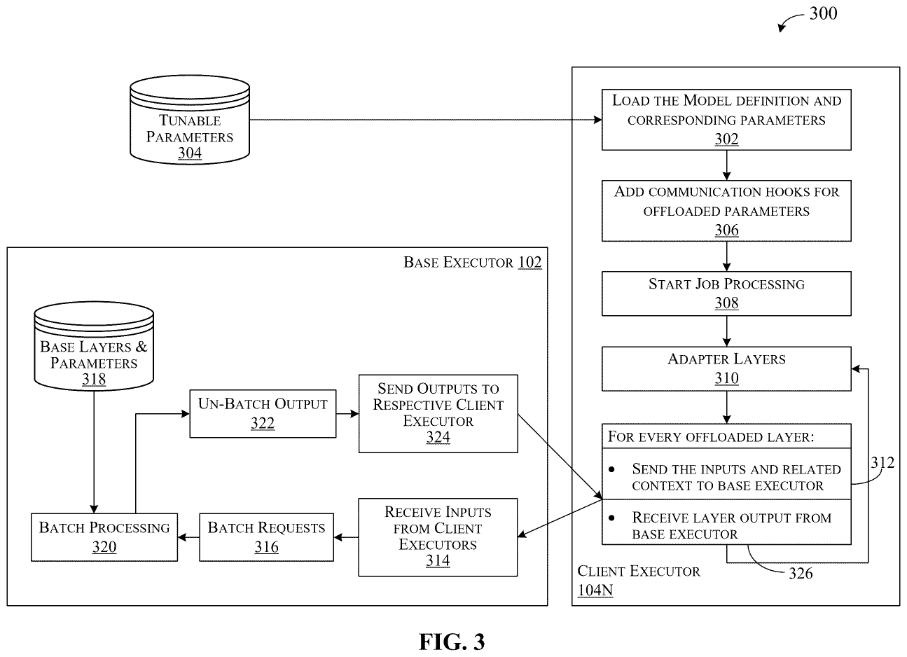

MMIFT framework 100 implements a client-server paradigm in which base executor 102 operates as a server that makes individual base layers of base layers 112 independently available to client executors 104A-104N. Base layers 112 comprises neural network layers (e.g., input, hidden, and output layers) of a large, pre-trained model (e.g., foundation model), such as an LLM or other generative AI model. Client executors 104A-104N comprise adapter layers for either fine tuning the pre-trained, large model for a specific task or for generating an inference with the pre-trained, large model already adapted to a specific inference task. For a batch of input data, a client executor invokes base executor 102 for processing input data with one or more specific base layers of base layers 112. Client executors convey input data to base executor 102 for processing, and upon receiving base executor 102's processing outputs, the respective client executors continue executing forward or backward passes through the adapter layers therein until task completion or until another offloading of a base layer computation to base executor 102 (FIG. 3). The client-server model implemented by MMIFT framework 100 thus splits execution of the adapter layers by client executors 104A-104N from execution of base layers by base executor 102, thereby enabling base executor 102 to execute the base model layers and each of client executors to execute their own task-specific adapter layers.

Base executor 102 may simultaneously serve client executors 104A-104N, which thus are able to share compute and memory resources. During inference or fine tuning of the base layers corresponding to the pre-trained model, client executors 104A-104N offload base layer computations to base executor 102 using communication hooks 110A-110N. Communication hooks 110A-110N are added to each of the base layers thereby enabling base executor 102 to perform the computations independently with respect to each base layer. Base executor 102 receives multiple requests from client executors 104A-104N and batches the requests to maximize throughput and meet the latency requirements of the client executors 104.

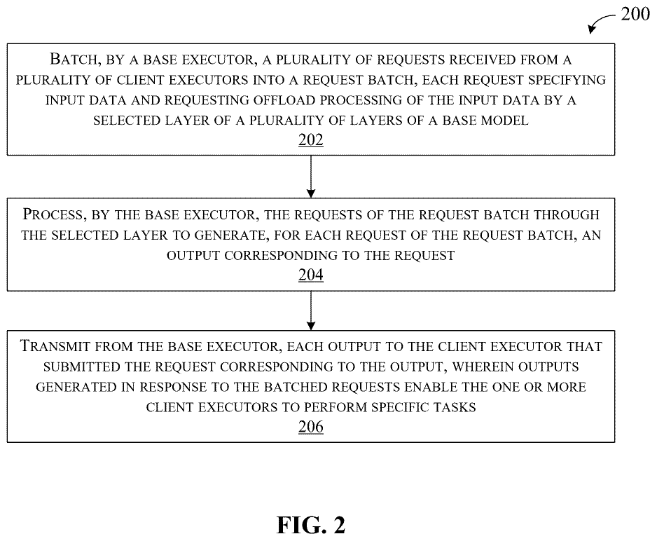

FIG. 2 illustrates an example method 200 of operation of base executor 102 of MMIFT framework 100 of FIG. 1. Referring to FIGS. 1 and 2 collectively, in block 202, batch handler 106 batches a plurality of requests received from a plurality of client executors into a request batch. Each request specifies input data and requests offload processing of the input data by a selected layer of the plurality of layers of base layers 112 of base executor 102. In different embodiments described below different batching criteria may be applied by base executor 102 to maximize throughput or minimize latency or to balance throughput and latency in processing requests.

MMIFT framework 100 enables a user to customize the selection of base model layers to which the user wishes to offload computation(s) to base executor 102 as part of a client executor's fine tuning or performing an inference. The layer-as-a-service capability of MMIFT framework 100 enables the user to invoke layer-level offloading by specifying one or more layers in a request to base executor 102. For example, a request of a client executor invoking offloading computation to a specified layer in a forward pass or a backward pass redirects model execution from the client executor to base executor 102. The performance of the computation on the base layer selected by a client executor is transparent, different client executors may implement different adapters. The different adapters may be ones trained to fine tune the pre-trained model to perform a specific task, for example, or for performing generating an inference with the pre-trained model already adapted for a specific task. Moreover, each of client executors 104A-104N drives fine tuning or inference independently of the other client executors, allowing MMIFT framework 100 to accommodate different execution rates for different adapters. For example, client executor may request a first layer of base layers 112, while client executor 104B requests a tenth layer of base layers 112 and client executor 104N requests still a different layer of base layers 112.

In block 204, batch processor 108 processes the requests of the request batch through the selected layer to generate, for each request of the request batch, an output corresponding to the request. Each output is generated by passing input data received with the batched requests through the selected base layer, thereby transforming the input data. Any one of client executors 104A-104N submitting a request may implement a trainer for performing fine-tuning tasks or an inference client for generating an inference. Passing inputs through client executor-selected base layers performs calculations that transform the input into an output, the specific calculation and resulting transformation depending on the specific base layer(s) through which the inputs are passed. The inputs passed with a request to offload computation to base executor 102 may comprise tensors. Passing the inputs through the one or more selected base layers may comprise a forward pass or a backward pass of a tensor through the base layer(s). MMIFT framework 100 permits users to customize a client executor to select the specific base layer or layers for performing a computation offloaded to base executor 102 by passing the tensor through the base layer(s) to generate an output. During a forward pass, base executor 102 need not save the input unless needed for calculating a gradient in a corresponding backward pass. Although, parameters of base layers 112 remain fixed, fine tuning may be performed by backward passing tensors through the base layers. Thus, parameters (e.g., weights) of the fixed-parameter base layers 112 are not updated, but gradients are nonetheless propagated through the base lasers and used for updating tunable or trainable parameters of non-fixed parameter layers (e.g., weights of non-fixed adapter layers).

In block 206, base executor 102 transmits each output to the client executor that submitted the request corresponding to the output. An output generated by base executor 102 and transmitted to a client executor may serve as an input to an adapter layer of the client executor and used by the client executor for fine tuning. The output generated by base executor 102 and transmitted to a client executor may serve as an input to a layer of a model adapted from the large model and used by the client executor to generate an inference. Whether for fine tuning or generating an inference, each output transmitted to a client executor may be used by the client executor as input to another adapter layer of the adapter implemented by the client executor, in which case the client executor may subsequently submit another request to offload computation to a base layer. The process may be repeated until and as often as needed for completing fine tuning of an adapter or generating an inference by the client executor. The outputs generated in response to the batched requests thus enable the one or more client executors to perform specific tasks.

Referring additionally now to FIG. 3, certain operative aspects 300 of MMIFT framework 100 with respect to client executors 104A-104N are illustrated. Illustratively, client executor 104N in block 302 loads the definition and corresponding parameters 304 of a client model, which is adapted from the large or foundation model. One or more communication hooks 110N are added in block 306 to enable client executor 104N to offload parameters to base executor 102. Communication hooks 110A-110N, generally, are transparently added through an offloading mechanism to the base layers to enable base executor 102 to serve the base layers independently in response to batched requests. In block 308, client executor 104N initiates a processing job (e.g., fine tuning or inference) through adapter layers 310. In block 312, one or more computations are offloaded to base executor 102. The offloading is initiated by client executor 104N's sending a request specifying information such as metadata that includes client id, client-specified base layer, and activations to be provided to the specified base layer as input data. The request also may specify a related context. The related context is information provided to the base executor 102 and may vary according to the specific implementation of the base executor. For example, in certain embodiments, the related context contains information such as input/output dimensions of the layers, whether the client executor is an inference-generating client or a fine-tuning client (e.g., trainer), and whether the request is a forward or backward request.

The related context is conveyed via a request to batch handler 106, which in block 314 adds the request and input data with other requests being accumulated for batching. Batch handler 106 batches the requests in block 316 and conveys the batched requests to batch processor 108. Batch processor 108 uses base layers and base parameters 318, which remain fixed, for processing the requests in block 320. Batch processor 108 is capable of submitting each request of the batch serially through the selected layer of base layers 112. Batch processor 108 may store or capture the individual outputs of the batch as generated by the selected layer.

Batch handler 106, in block 322, un-batches the outputs generated by batch processing in block 320 for a given batch. In block 324, base executor 102 sends the outputs to respective client executors. Client executor 104N receives an output in response to the request conveyed in block 326 and resumes processing at a next layer of adapter layers 310 using the output received as an input to the next adapter layer. The process may be repeated as often as needed for completing fine tuning of an adapter or generating an inference with an adapter by client executor 104N.

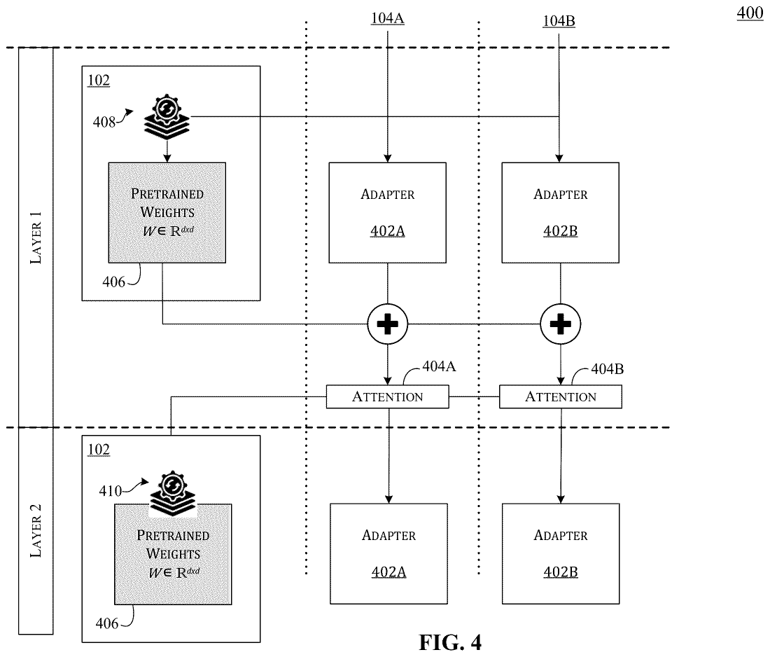

FIG. 4 illustrates operations 400 pertaining to individual layer-level processing by MMIFT framework 100. Illustratively, client executors 104A and 104B implement trainers for guiding a fine-tuning process, handling data preprocessing, tuning hyperparameters, and performing other aspects related to fine tuning the base model. As trainers, client executors 104A and 104B include adapters 402A and 402B, respectively, each of which adapts the base model to perform a different, specific task. In addition to the adapters, client executors 104A and 104B illustratively include attention mechanisms 404A and 404B, which increase model accuracy by differentially weighting different portions of input data according to relevance. Operations 400 illustrate MMIFT framework 100's response to client executors 104A and 104B each invoking base executor 102 to perform offloaded computations based on pretrained weights 406. At layers 1 and 2, client executors 104A and 104B send, via communication hooks 110A and 110B, respectively, requests including inputs (e.g., client id, client-specified base layer, activations, and/or other metadata) to base executor 102. At layer 1, base executor 102 batches the requests, creating batch 408, and generates outputs in response to the requests in the batch. Base executor 102 transmits the outputs to client executors 104A and 104B. Upon receiving outputs in response to the respective requests, executor clients 104A and 104B continue with a forward or backward pass by combining the outputs received from base executor 102 with outputs of the respective adapters 402A and 402B. The resulting combination of outputs for each client executor is fed into attention mechanisms 404A and 404B, respectively. The process is repeated at layer 2. Client executors 104A and 104B submit requests for layer 2. The process may continue until a final training epoch is completed or an inference is generated by client executors 104A and 104B, depending on the specific task. With respect to inference, an inference result is returned to the user, whereas for fine-tuning, the client executor performs model parameter updates by, for example, running an optimizer.

In certain embodiments, to transparently redirect computation from client executors 104A-104N to a base layer instantiated as part of base executor 102, the base layers—which remain “frozen” with immutable parameters—may be replaced with a custom virtual layer. The parameters of the replaced layers are not loaded during initialization (block 302), meaning that the footprint of a client executor's model is small. Tunable layers may be removed from the model structure of base executor 102, so that the base executor serves only the remaining layers to client executors 104A-104N for performing computations.

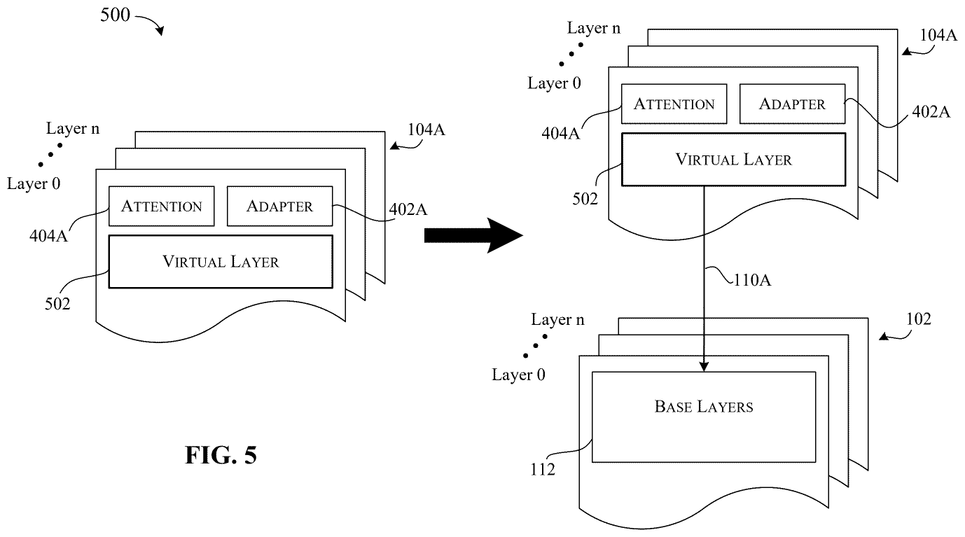

These aspects in some embodiments of MMIFT framework 100 are implemented with PyTorch or other machine learning library. Using PyTorch, for example, MMIFT framework 100 may scan and replace the frozen layers of the base model with VirtLayer, which is an instance of torch.nn.Module. MMIFT framework 100 implements the forward and backward functions of VirtLayer to intercept inputs coming to the base layer, perform layer computations on base executor 102, and return the results generated as the output conveyed to a client executor. These aspects are illustrated in FIG. 5 by operation 500 of VirtLayer (an instance of the PyTorch torch.nn.Module). Illustratively, a base layer offload request of client executor 104A, implemented as a trainer (FIG. 4), is intercepted by virtual layer 502 (e.g., implemented as VirtLayer with PyTorch) and is redirected to base executor 102. Virtual layer 502 invokes communication hook 110A, which may include forward and/or backward tensor redirection hooks capable of passing gradients and/or activations between client executor 104A and base executor 102. Virtual layer 502 is utilized by client executor 104A for fine tuning or inference.

More generally, MMIFT framework 100 in certain embodiments configures the forward pass and backward pass functions of VirtLayer to intercept requests of client executors 104A-104N coming to the base layer and convey the intercepted requests to base executor 102. In response, base executor 102 performs layer computations with respect to the requested base layers hosted by base executor 102, and VirtLayer returns results received from base executor 102 to the client executors. VirtLayer resides solely at a client executor, its role being to send inputs to and receive outputs from base executor 102. The forward pass and backward pass functions of VirtLayer have the same properties, same return datatypes, and same sizes as the corresponding functions of the base model layers. When invoked, the functions send metadata (e.g., client id, client-specified base layer) and activations (tensors) to base executor 102 for processing. The functions, upon receiving outputs transmitted by base executor 102, return the activations (forward pass) or gradients (backward pass) to the respective client executors 104A-104N, which continue executing the corresponding fine tuning or inference operations.

An already noted aspect of MMIFT framework 100 is the capability to simultaneously, or nearly so, support the execution of requests pertaining to both fine tuning and generating by processing a single batch of requests. Different users may have different performance objectives for individual client executors served by base executor 102. For example, client executors engaged in implementing an adapted version of the large model to generate an inference prefer low latency, whereas conversely, ones engaged in fine tuning an adapter likely care more about throughput.

In one or more embodiments, MMIFT framework 100 is capable of batching requests for offloading computation based on the particular base layer requested by each batch. That is, those requests that request the same base layer may be batched together into a same request batch. Accordingly, in at least some embodiments, each batch will include only requests for the same base layer.

In certain embodiments, requests may be selected by base executor 102 for batching by identifying forward pass requests among multiple requests received. At least one of the forward pass requests may relate to inference generation and at least one of the forward pass requests may relate to fine tuning. Base executor 102 may batch the forward pass requests identified and generate outputs in response to the requests by forward passing data received with each of the forward pass requests through one or more selected base layers. Throughput may be enhanced by processing forward pass requests involving both fine tuning and inference generation in a single batch rather than separately.

In some embodiments, MMIFT framework 100 may enhance throughput by waiting until a predetermined number of requests for offloading computation to the same base layer(s) are received before batching the requests and processing the batch. In other embodiments, MMIFT framework 100 may reduce latency, by setting a time limit for receiving requests for offloading computation to the same base layer(s), batching requests received before the time expires and processing the batch regardless of the number of such requests. MMIFT framework 100, in still other embodiments, may implement other batching techniques.

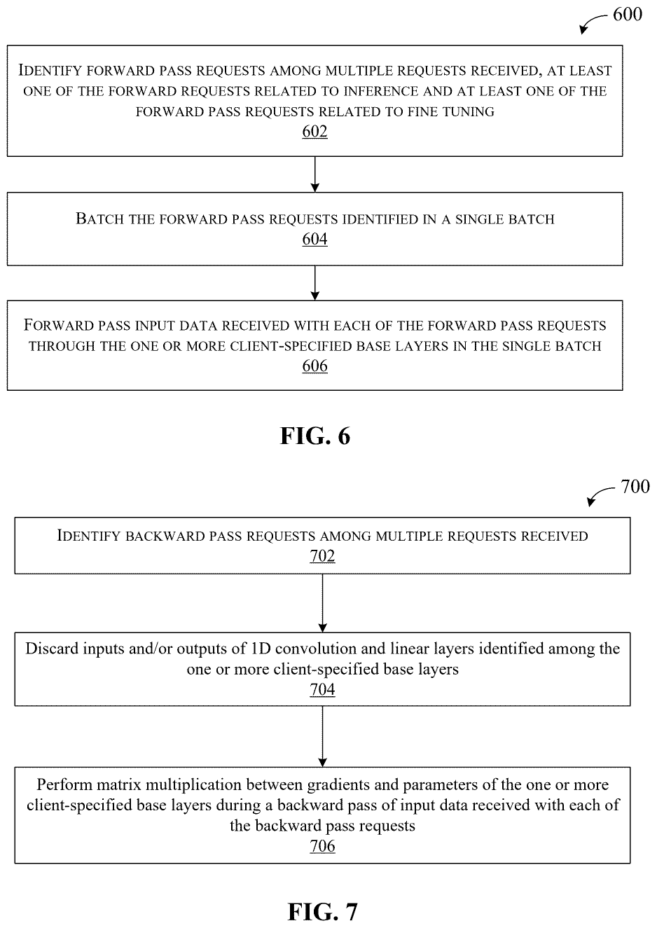

FIG. 6 illustrates an example method 600 of batching multiple processing requests received from client executors 104A-104N by a base executor 102. In block 602, batch handler 106 selects requests for batching by identifying forward pass requests among the requests received from client executors 104A-104N. The requests specify the specific base layer that each requesting client executor is requesting computation be offloaded to base executor 102. In block 604, batch handler 106 batches the forward pass requests identified. The requests batched may be ones that arrive within a predetermined time interval and are ones that each request offloading to the same base layer. In block 606, batch processor 108 generates outputs by forward passing input data received with each of the forward pass requests identified through one or more selected base layers, the base layers selected in accordance with the forward pass requests identified. The forward pass requests may pertain to fine tuning or generating an inference by the requesting client executors. Thus, fine-tuning requests and inference-related requests are processed in the same batch. To enhance throughput, batching may be performed only if a predetermined number of requests are received. At each layer, processing may wait until the predetermined number of requests are accumulated. To avoid indefinite waiting, however, a time limit for receiving the predetermined number of requests may be set.

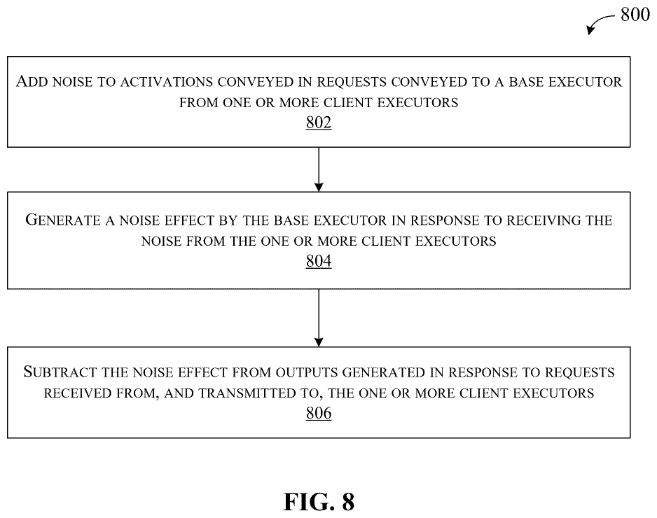

FIG. 7 illustrates an example method 700 of batching multiple processing requests received from client executors 104A-104N by a base executor 102. In block 702, batch handler 106 identifies backward pass requests among multiple requests received. In block 704, batch processor 108 discards inputs and/or outputs of 1D convolution and linear layers identified among the one or more selected base layers. In block 706, batch processor 108 generates output by performing matrix multiplication between gradients generated by gradient functions of client executors and parameters of one or more selected base layers selected based on the requests, the matrix multiplication is performed during a backward pass of input data received with each of the backward pass requests identified. With conventional methods each client executor needs to wait in lockstep for all other client executors to complete client-side executions. Thus, if inference-related and fine-tuning requests are batched together in which the same tensors are used in forward passes as gradient-determining backward passes, then with conventional lockstep processing both requests must wait for completion of the backward pass even though inference-related requests do not need to go through backward passes.

Method 700 breaks this lockstep and substitutes the matrix multiplication with respect to gradients to enable processing the forward pass with backward pass requests without slowing the processing of the former having to wait on the latter. This is based on recognition, first, that parameters of the one or more selected base layers are frozen and do not need to be updated by a backward pass. Second is the recognition that the largest fraction of many large model architectures (e.g., LLM architectures) are linear and 1D convolution layers. Input and output of these layers are not involved in calculating gradients since the gradient output with respect to the input is resolved with the parameters themselves. Accordingly, there is no need to store the input or output even for fine tuning. Method 700 instead relies on the matrix multiplication between the output and the parameters to generate required gradients during the backward pass. Matrix multiplication is performed in lieu of computing gradients. This also eliminates the need to store forward feed input/output tensors at base executor 102 until a backward pass is completed, which effects a significant reduction in memory consumption. Method 700 also breaks the lockstep in batch processing multiple requests, allowing different client executors' requests to be processed by batch processor 108 at different rates of execution. More latency-sensitive requests such as the inference-related requests, for example, can be processed faster. Method 700 also provides significant memory saving by obviating base executor 102's having to store input and output tensors for each client executor.

In still other embodiments, MMIFT framework 100 may implement a gradual lockstep mechanism. Gradual lockstep relies on the techniques for breaking lockstep execution of model layers by client executors as already described in connection with FIG. 7. In accordance with the gradual lockstep mechanism, the speeds with which client executors 104A-104N pass input data through layers of the models implemented (adapter layers), respectively, by each is detected. The speeds are detected as the input data is passed through an initial set of layers in accordance with a lockstep requirement. The lockstep requirement sets a time for batching requests to offload processing to base executor 102. The time is established by batch handler 106's detecting the time in which each client executor 104A-104N passes input data through an initial set of layers, after which the lockstep requirement is successively relaxed with each new round of batching requests. The lockstep requirement is successively relaxed by batch handler 106 until each client executor 104A-104N has passed input data through every layer of the models implemented, respectively, by each client executor. Differences in speed may arise because of various factors, such as longer sequences to process, a larger key-value (KV) cache that increases the duration of attention calculation, and/or differences in the capabilities of the hardware on which client executors 104A-104N are running. Gradually lowering the lockstep requirement allows a faster client executor to proceed through subsequent layers more rapidly by not having to wait on a slower client executor. To avoid indefinite waiting, batch handler 106 may implement different timeouts for inference-related and fine-tuning requests, after which requests are batched for processing by base executor 102 regardless of the batch size.

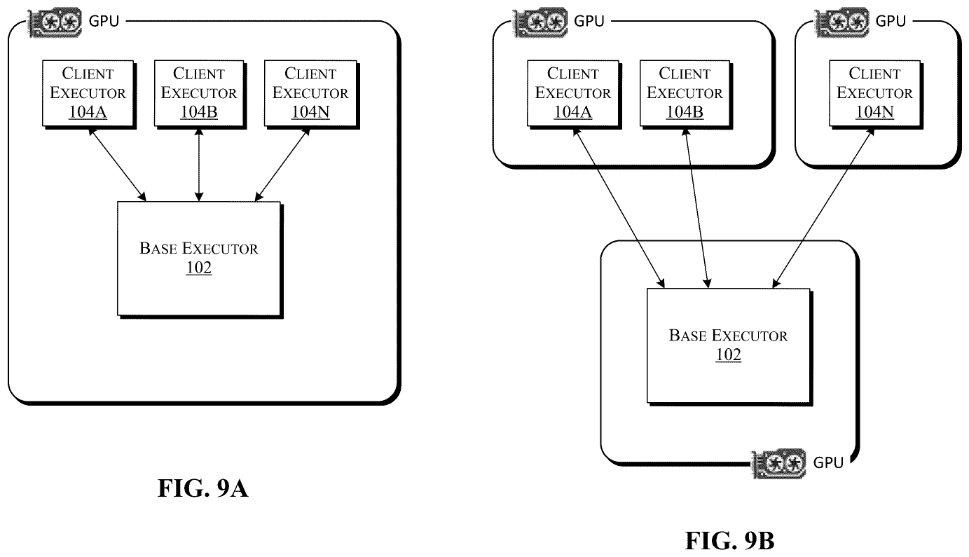

In certain embodiments, MMIFT framework 100 implements measures to protect data shared by client executors 104A-104N with base executor 102. FIG. 8 illustrates a method implemented by MMIFT framework 100 for providing differential privacy to users. In block 802, a client executor's user desiring privacy adds noise to activations conveyed by client executors 104A-104N in the requests to base executor 102. Activations are generated by activation functions that are part of the layers of the models implemented by client executors 104A-104N. Output generated by batch processor 108 in response to input (activations) to which noise is added are characterized as noisy output, y_{noisy}, which in certain embodiments is generated as the output of a 1D convolution layer:

$$\begin{matrix}{y}_{noisy} = Con 1 D ( x + n , W ) + b \\ = Con 1 D ( x , W ) + Con 1 D ( n , W ) + b\end{matrix}$$

where n is noise added to activation x, W is a model weight matrix and bias, b. In block 804, base executor 102 generates noise effect, n_{effect}:

$${n}_{effect} = Con 1 D ( n , W ) .$$

The noise effect is generated in response to separately receiving noise n from the client executor and using it to calculate noise effect, n_{effect}. In block 806, base executor 102 subtracts the noise effect from the output y generated in response to requests received,

$$y = ( Con 1 D ( x , W ) + Con 1 D ( n , W ) + b ) - Con 1 D ( n , W ) ,$$

and transmits the output to the client executor. The base model shared between base executor 102 and client executors 104A-104N, as noted, corresponds to a pre-trained model, such as an LLM or another large model. Such models typically include convolutional and linear layers. Thus, in calculating the effect of noise, base executor 102 in certain embodiments may leverage the convolution and linear layers of the base model. An interface may be added to the base model's original layers to nullify the effect of bias. To avoid repeated calculations of the noise effect, base executor 102 may pre-calculate the value only once for a given noise, n. Pre-calculation of the noise effect saves multiple, per-layer round trips of input/output exchanges between base executor 102 and client executors 104A-104N.

To determine which processing with respect to which layers may be offloaded to base executor 102 by a client executor, MMIFT framework 100 may define a configuration for each model type implemented by client executors 104A-104N. Convolution and linear layer computations, for example, may be offloaded to base executor 102. A model builder implemented by MMIFT framework 100 may modify a configuration to move execution of a layer from base executor 102 to a client executor. Moreover, using the model builder, a model developer may incrementally build upon a previously fine-tuned adapter implemented by a client executor.

An aspect of the model builder is that a client executor does not need to execute all base layers 112 hosted by base executor 102. The model builder API allows the client executor to select which base layers of the base model to offload to base executor 102. Different client executors connected to base executor 102 may offload different base layers. This gives each client executor full control over the location of each of their layers. This aspect enables MMIFT framework 100 to support instances in which a client executor may want to fine-tune one or more of base layers 112. Another aspect, with respect to fine-tuning, is that the model builder enables all client executors to fine-tune the same adapter but with different data and/or fine-tune the adapter for different tasks using different data. In such cases, the model builder allows the base executor to host a common adapter that all clients use.

Thus, in certain embodiments one of client executors 104A-104N may implement a model layer of an adapter, which is a previously fine-tuned adapter. The previously fine-tuned adapter may have been fine-tuned according to the methods as described above with respect to base executor 102. The client executor may push the previously fine-tuned adapter onto base executor 102. Accordingly, the previously fine-tuned adapter is accessible to other client executors. The previously fine-tuned adapter may be accessible at a selected endpoint. With the previously fine-tuned adapter pushed onto base executor 102, output may be generated for fine tuning a new adapter implemented by at least one of client executors 104A-104N. The output is generated by passing input data received in a request from at least one of the client executors 104A-104N through the selected endpoint.

FIGS. 9A-9D illustrate alternate configurations of base executor 102 and client executors 104A-104N. Splitting execution of the fine tuning and/or inference processes between base executor 102 and client executors 104A-104N enables flexible placement of the base executor and client executor(s) with respect to one another. As illustrated in FIG. 9A, one or more client executors 104A-104N may be deployed on the same hardware (e.g., GPU) as base executor 102. This configuration allows for fast communication between base executor 102 and the client executor(s), as well as memory resources sharing. Splitting execution of the fine tuning and/or inference processes, moreover, enables independent scaling of base executor 102 and client executors 104A-104N despite being executed on same hardware. In an alternate arrangement, illustrated in FIG. 9B, client executors 104A-104N may be deployed on hardware components (e.g., GPU, CPU) of the same or different nodes or devices separate from the hardware on which base executor 102 is deployed. The arrangement supports those client executors that may need higher memory for large input batch sizes, for example. As with the arrangement illustrated in FIG. 9A, the arrangement illustrated in FIG. 9B also allows client executors 104A-104N to scale independently of base executor 102.

Splitting execution of the fine tuning and/or inference processes between base executor 102 and client executors 104A-104N also allows for the sharding of models across different GPUs, for example, as illustrated in FIGS. 9C and 9D. Sharding reduces the memory footprint per hardware component. In executing computations offloaded to base executor 102, only parameters corresponding to the specific layer(s) corresponding to the computations are fetched from the GPUs. After execution, fetched parameters are released, freeing memory. A sharded local configuration, as in FIGS. 9C and 9D, allows scaling of base executor 102 across multiple GPUs by sharding base layer weights across the GPUs. Client executors 104A-104N may reside in any one of multiple GPUs where a shard of the base model resides. Base executor 102 provides a communication endpoint at each GPU in which base layers are sharded. A client executor needs only communicate with a locally sharded layer.

In the various configurations illustrated in FIGS. 9A-9D each of client executors 104A-104N is capable of maintaining a runtime state separately from and independently of the other client executors. In one or more embodiments, the open-source Nvidia Communication Collectives Library (NCCL)® available from NVIDIA may be used with functions such as nccl.send(s) and nccl.recv( ) being invoked for communication between base executor 102 and client executors 104A-104N if the base executor resides on a separate node or device from one or more client executors. In one or more other embodiments, similar communication functions available with open-source ROCm Communication Collectives Library (RCCL) developed by Advanced Micro Devices, Inc or open-source Intel oneAPI Collective Communications Library (oneCCL)® developed by Intel may be used for communications between base executor 102 and client executors 104A-104N.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner that at least partially overlaps in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 10, computing environment 1000 contains an example of an environment for the execution of at least some of the computer code in block 1050 involved in performing the inventive methods, such as MMIFT framework 100 implemented as executable program code or instructions. MMIFT framework 100 provides a deployment-as-a-service of base model layers. The base model layers provided by MMIFT framework 100 may be shared across multiple inference or fine-tuning processes. The split-execution of MMIFT framework 100 decouples execution of client-specific adapters and layers from the frozen layers of the base model of a pre-trained, large model such as an LLM or other generative AI system, providing flexibility for managing resources and selecting a fine-tuning method for achieving performance goals. In various embodiments, MMIFT framework 100 is transparent to models and may function out-of-the-box for diverse models in a transformer or other AI library, providing a collection of tools and pre-trained models that facilitate the use of a transformer or other AI model architecture.

Computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and block 1050, as identified above), peripheral device set 1014 (including user interface (UI) device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

Computer 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 may be located in a cloud, even though it is not shown in a cloud in FIG. 10. On the other hand, computer 1001 is not required to be in a cloud except to any extent as may be affirmatively indicated.

Processor set 1010 includes one, or more, computer processors of any type now known or to be developed in the future. Processing circuitry 1020 may be distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 may be designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in block 1050 in persistent storage 1013.

Communication fabric 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

Persistent storage 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 may be a read only memory (ROM), but typically at least a portion of the persistent storage allows writing of data, deletion of data and re-writing of data. Some familiar forms of persistent storage include magnetic disks and solid-state storage devices. Operating system 1022 may take several forms, such as various known proprietary operating systems or open-source Portable Operating System Interface type operating systems that employ a kernel. The code included in block 1050 typically includes at least some of the computer code involved in performing the inventive methods.

Peripheral device set 1014 includes the set of peripheral devices of computer 1001. Data communication connections between the peripheral devices and the other components of computer 1001 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 may be persistent and/or volatile. In some embodiments, storage 1024 may take the form of a quantum computing storage device for storing data in the form of qubits. In embodiments where computer 1001 is required to have a large amount of storage (e.g., where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

Network module 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (e.g., embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

EUD 1003 is any computer system that is used and controlled by an end user (e.g., a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 may be a client device, such as thin client, heavy client, mainframe computer, desktop computer and so on.

Remote server 1004 is any computer system that serves at least some data and/or functionality to computer 1001. Remote server 1004 may be controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

Public cloud 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The terminology used herein is for the purpose of describing particular embodiments only and is not intended to be limiting. Notwithstanding, several definitions that apply throughout this document now will be presented.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), a graphics processing unit (GPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, the term “user” refers to a human being.

The terms “first,” “second,” etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
batching, by a base executor, a plurality of requests received from a plurality of client executors into a request batch, wherein each request specifies input data and requests offload processing of the input data by a selected layer of a plurality of layers of a base model by the base executor;
processing, by the base executor, the requests of the request batch through the selected layer to generate, for each request of the request batch, an output corresponding to the request; and
transmitting, from the base executor, each output to the client executor that submitted the request corresponding to the output, wherein the outputs generated in response to the batched requests enable the one or more client executors to perform specific tasks.

2. The computer-implemented method of claim 1, wherein the specific tasks include at least one inference task and at least one fine-tuning task.

3. The computer-implemented method of claim 1, wherein the request batch includes only forward pass requests.

4. The computer-implemented method of claim 1, wherein the batching and processing the request batch includes:
identifying backward pass requests among multiple requests received;
discarding at least one of inputs or outputs of 1D convolution and linear layers identified among the plurality of layers of the base model; and
generating outputs by performing matrix multiplication between gradients and parameters of one or more selected base layers during a backward pass of input data received with each of the backward pass requests.

5. The computer-implemented method of claim 1, wherein the batching and processing the batched requests include:
detecting speeds with which the plurality of client executors pass input data through layers of models implemented, respectively, by each client executor, wherein the input data is passed through an initial set of layers in accordance with a lockstep requirement; and
successively relaxing the lockstep requirement until each client executor has passed input data through every layer of the models implemented, respectively, by each client executor.

6. The computer-implemented method of claim 1, further comprising:
adding noise to activations conveyed in requests received by the base executor from one or more of the client executors;
generating a noise effect by the base executor in response to receiving the noise from the one or more client executors and subtracting the noise effect from outputs generated in response to requests received from, and transmitted to, the one or more client executors.

7. The computer-implemented method of claim 1, wherein one of the plurality of client executors implements a previously fine-tuned adapter, the method further comprising:
pushing the previously fine-tuned adapter onto the base model, wherein the previously fine-tuned adapter is accessible to the plurality of client executors at a selected endpoint of the base executor; and
generating an output for fine tuning a new adapter implemented by at least one of the plurality of client executors, wherein the output is generated by passing input data received in a request from the at least one of the plurality of client executors through the selected endpoint.

8. A system, comprising:
one or more processors capable of initiating operations including:
batching, by a base executor, a plurality of requests received from a plurality of client executors into a request batch, wherein each request specifies input data and requests offload processing of the input data by a selected layer of a plurality of layers of a base model by the base executor;
processing, by the base executor, the requests of the request batch through the selected layer to generate, for each request of the request batch, an output corresponding to the request; and
transmitting, from the base executor, each output to the client executor that submitted the request corresponding to the output, wherein the outputs generated in response to the batched requests enable the one or more client executors to perform specific tasks.

9. The system of claim 8, wherein the specific tasks include at least one inference task and at least one fine-tuning task.

10. The system of claim 8, wherein the request batch includes only forward pass requests.

11. The system of claim 8, wherein the batching and processing the request batch includes:
identifying backward pass requests among multiple requests received;
discarding at least one of inputs or outputs of 1D convolution and linear layers identified among the plurality of layers of the base model; and
generating outputs by performing matrix multiplication between gradients and parameters of one or more selected base layers during a backward pass of input data received with each of the backward pass requests.

12. The system of claim 8, wherein the batching and processing the batched requests include:
detecting speeds with which the plurality of client executors pass input data through layers of models implemented, respectively, by each client executor, wherein the input data is passed through an initial set of layers in accordance with a lockstep requirement; and
successively relaxing the lockstep requirement until each client executor has passed input data through every layer of the models implemented, respectively, by each client executor.

13. The system of claim 8, wherein the one or more processors are configured to initiate operations further including:
adding noise to activations conveyed in requests received by the base executor from one or more of the client executors;
generating a noise effect by the base executor in response to receiving the noise from the one or more client executors and
subtracting the noise effect from outputs generated in response to requests received from, and transmitted to, the one or more client executors.

14. A computer program product, the computer program product comprising:
one or more computer-readable storage media and program instructions collectively stored on the one or more computer-readable storage media, the program instructions executable by a processor to cause the processor to initiate operations including:
batching, by a base executor, a plurality of requests received from a plurality of client executors into a request batch, wherein each request specifies input data and requests offload processing of the input data by a selected layer of a plurality of layers of a base model by the base executor;
processing, by the base executor, the requests of the request batch through the selected layer to generate, for each request of the request batch, an output corresponding to the request; and
transmitting, from the base executor, each output to the client executor that submitted the request corresponding to the output, wherein the outputs generated in response to the batched requests enable the one or more client executors to perform specific tasks.

15. The computer program product of claim 14, wherein the specific tasks include at least one inference task and at least one fine-tuning task.

16. The computer program product of claim 14, wherein the request batch includes only forward pass requests.

17. The computer program product of claim 14, wherein the batching and processing the batched requests include:
identifying backward pass requests among multiple requests received;
discarding at least one of inputs or outputs of 1D convolution and linear layers identified among the plurality of layers of the base model; and
generating outputs by performing matrix multiplication between gradients and parameters of one or more selected base layers during a backward pass of input data received with each of the backward pass requests.

18. The computer program product of claim 14, wherein the batching and processing the request batch includes:
detecting speeds with which the plurality of client executors pass input data through layers of models implemented, respectively, by each client executor, wherein the input data is passed through an initial set of layers in accordance with a lockstep requirement; and
successively relaxing the lockstep requirement until each client executor has passed input data through every layer of the models implemented, respectively, by each client executor.

19. The computer program product of claim 14, wherein the program instructions are executable by the processor to cause the processor to initiate operations further including:
adding noise to activations conveyed in requests received by the base executor from one or more of the client executors;
generating a noise effect by the base executor in response to receiving the noise from the one or more client executors and
subtracting the noise effect from outputs generated in response to requests received from, and transmitted to, the one or more client executors.

20. The computer program product of claim 14, wherein one of the plurality of client executors implements a previously fine-tuned adapter, and wherein the program instructions are executable by the processor to cause the processor to initiate operations further including:
pushing the previously fine-tuned adapter onto the base model, wherein the previously fine-tuned adapter is accessible to the plurality of client executors at a selected endpoint of the base executor; and
generating an output for fine tuning a new adapter implemented by at least one of the plurality of client executors, wherein the output is generated by passing input data received in a request from the at least one of the plurality of client executors through the selected endpoint.
